(19) United States
(12) Patent Application Publication
(10) Pub. No.: US 2024/0325252 A1
(43) Pub. Date: Oct. 3, 2024

(54) MANUFACTURING DEVICE AND METHOD FOR PERSONALIZED SOFTGEL CAPSULE

(71) Applicant: Wuhan Kornnac Technology Co., Ltd., Hubei (CN)

(72) Inventors: Xianghan Zhou, Hubei (CN); Ye Chen, Hubei (CN); Tian Xie, Hubei (CN); Zhiyu Cai, Hubei (CN); Fulin Wu, Hubei (CN); Fei Xiong, Hubei (CN)

(73) Assignee: Wuhan Kornnac Technology Co., Ltd., Hubei (CN)

(21) Appl. No.: 18/396,740

(22) Filed: Dec. 27, 2023

(30) Foreign Application Priority Data
Mar. 28, 2023 (CN) 202310335650.0

(51) Int. Cl. A61J 3/07; A61J 3/00

(52) U.S. Cl. CPC A61J 3/07; A61J 3/007

(57) ABSTRACT

The disclosure provides a manufacturing device and a manufacturing method for personalized softgel capsules. The manufacturing device includes a first capsule forming unit, a second capsule forming unit, a pump spray body, a printing unit and a control unit. The first capsule forming unit and the second capsule forming unit are arranged symmetrically on left and right, and both of them include a casting drum, several feeding rollers and a pilling mold that are disposed in sequence from front to back, and also include a spreading box arranged above the casting drum. The pump spray body is disposed directly above the two pilling molds. The printing unit includes a printing nozzle, a left and right correction assembly and a front and rear correction assembly that are disposed on the first capsule forming unit in sequence from front to back. The control unit is connected to the printing unit.

### CROSS-REFERENCE TO RELATED APPLICATION

This application claims the priority benefit of China application serial no. 202310335650.0, filed on Mar. 28, 2023. The entirety of the above-mentioned patent application is hereby incorporated by reference herein and made a part of this specification.

### BACKGROUND

### Technical Field

The disclosure belongs to the field of softgel capsule production, and more specifically, relates to a manufacturing device and a method for personalized softgel capsules.

### Description of Related Art

Personalized softgel capsule printing is a relatively new demand on market and is currently in the initial stage. As people's health awareness continues to increase and the needs for personalized product continue to grow, the softgel capsule market is gradually expanding. Therefore, there is a great potential for development of market for personalized softgel capsule printing.

Although personalized softgel capsule printing has a broad market prospect, the business encounters some technical problems in the process of realizing personalization, mainly including the following aspects: (a) Printing accuracy problem, the size of a softgel capsule is small, and the surface of the softgel capsule is oily after demoulding; it is difficult to ensure printing accuracy in the printing process to avoid problems such as blur, distortion, offset, etc.; (b) Printing process problems, the existing technology uses separate process equipment and fixed transfer mold to print pattern or information on softgel capsules, and therefore the content printed on the softgel capsules is relatively fixed and it is difficult to achieve online variable printing; (c) Production efficiency problem, customized softgel capsule printing requires mass production, how to improve printing efficiency and reduce production costs is an issue to be considered; (d) Color control problem, softgel capsule printing requires accurate control of the addition and proportion of colors to ensure the consistency and stability of the printing effect.

### SUMMARY

In view of the shortcomings of the existing technology, the purpose of the present disclosure is to provide a personalized softgel capsule manufacturing device and a method thereof, aiming to solve the problems of existing personalized softgel capsule printing device in terms of low accuracy, fixed printing content, low manufacturing efficiency, and unstable color consistency.

In order to achieve the above purpose, according to an aspect of the present disclosure, a personalized softgel capsule manufacturing device is provided, which includes a first capsule forming unit, a second capsule forming unit, a pump spray body, a printing unit and a control unit.

The first capsule forming unit and the second capsule forming unit are arranged symmetrically on left and right, and are respectively used to form gelatin sheets and compress them to form a pill. The structures of the first capsule forming unit and the second capsule forming unit are the same, and both of them include a casting drum, several feeding rollers and a pilling mold that are disposed in sequence from front to back along a transport direction of the gelatin sheet, and also include a spreading box arranged above the casting drum.

The pump spray body is disposed directly above the two pilling molds and is used to spray liquid into the pill to form a softgel capsule.

The printing unit includes a printing nozzle, a left and right correction assembly and a front and rear correction assembly that are disposed on the first capsule forming unit in sequence from front to back along a transport direction of the gelatin sheet. The printing nozzle is used to continuously print on the sheet printing surface of the gelatin sheet to form a pattern. The left and right correction assembly is used to detect the edges of the gelatin sheet to adjust the gelatin sheet to the left or right to ensure that the pattern is located in the center of the softgel capsule. The front and rear correction assembly is used to detect the pattern position and the rotation position and rotation angle of the pilling mold, and then adjust the printing position of the printing nozzle back and forth to ensure that the pattern is located in the center of the softgel capsule.

The control unit is connected to the printing unit and is used for receiving detection information and controlling the printing unit.

Moreover preferably, the printing nozzle adopts a one-shot printing mode.

Moreover preferably, the number of the printing nozzles is 1 to 10.

Moreover preferably, the printing unit further includes a dryer, which is disposed between the printing nozzle and the left and right correction assembly for drying the pattern.

Moreover preferably, the left and right correction assembly includes an edge sensor and a correction device disposed in sequence from back to front. The edge sensor is disposed above the gelatin sheet and is used to detect the edge of the gelatin sheet, and sends the detection information to the correction device. The correction device is disposed between two adjacent feeding rollers and is used to adjust the gelatin sheet to the left or right according to the detection information to ensure that the pattern is located in the center of the softgel capsule when the gelatin sheet enters the pilling mold.

Moreover preferably, the front and rear correction assembly includes a detection probe and an encoder disposed in sequence from front to back. The detection probe is disposed above the printing surface and is used to detect the pattern position on the gelatin sheet and send the detection information to the control unit. The encoder is disposed in the pilling mold to detect the rotation position and rotation angle of the pilling mold, and sends the detection information to the control unit, thereby using the control unit to adjust the printing position of the printing nozzle.

According to another aspect of the present disclosure, a method for manufacturing personalized softgel capsules using the above device is provided. The method includes the following steps:
S1. The gelatin liquid is dropped onto the casting drum through the spreading box and solidified into a gelatin sheet. One side of the gelatin sheet that fits the casting drum is a sheet seaming surface, and one side away from the casting drum is a sheet printing surface. Several feeding rollers are used to transport gelatin sheets.
S2. The printing nozzle is used to print patterns on the sheet printing surface and the gelatin sheet is continuously transported.
S3. The left and right correction assembly is used to detect the edges of the gelatin sheet, adjust the gelatin sheet to the left or right to ensure that the pattern is located in the center of the softgel capsule, and the gelatin sheet is continuously transported.
S4. The front and rear correction assembly is used to detect the pattern position and the rotation position and rotation angle of the pilling mold and transmits the data to the control unit. The control unit is used to adjust the printing position of the printing nozzle back and forth to ensure that the pattern is located in the center of the softgel capsule.
S5. The gelatin sheet enters the pilling mold for compression and heating, while the pump spray body injects liquid to form a patterned softgel capsule, thereby completing the production of personalized softgel capsules.

Moreover preferably, step S2 further includes: drying the pattern using the dryer.

Moreover preferably, step S3 specifically includes: using an edge sensor to detect the edge of the gelatin sheet, and sending the detection information to a correction device; the correction device adjusts the gelatin sheet to the left or right according to the detection information.

Moreover preferably, step S4 is specifically as follows: after the detection probe detects the pattern on the gelatin sheet, the detection probe sends an electrical signal to the control unit. In the meantime, the encoder detects the rotation position and rotation angle of the pilling mold, and sends the detection information to the control unit, the control unit adjusts the printing position of the printing nozzle back and forth according to the detection information to ensure that the pattern is located in the center of the softgel capsule.

Generally speaking, compared with the related art, the above technical solution conceived by the present disclosure has the following advantageous effects:
1. By adding a printing unit and a control unit to the conventional softgel capsule preparation device and optimizing the position and structure of the printing unit, the present disclosure may realize online variable information printing of the softgel capsule, thereby realizing personalized softgel capsule printing. By completing printing before pill compression, it is possible to avoid problems such as pattern blur, distortion, and offset caused by oil on the surface of the capsule. In the meantime, the control unit and the printing nozzle may be used to realize online variable content printing of patterns and precise color control. Also, the printing nozzle is adopted to achieve continuous and mass printing to effectively improve printing efficiency. Moreover, the left and right correction assembly and the front and rear correction assembly work together to ensure that the pattern is located in the center of the softgel capsule, thus further improving the printing effect.
2. Meanwhile, by optimizing the printing mode and quantity of the printing nozzles, the present disclosure may ensure that the printing speed is synchronized with the pilling speed, which helps to improve the production speed and efficiency of personalized softgel capsules.
3. In addition, the present disclosure may further improve the accuracy of online variable information printing of the softgel capsule by optimizing the structures of the left and right correction assembly and the front and rear correction assembly.

### BRIEF DESCRIPTION OF THE DRAWINGS

FIG. 1 is a schematic structural view of a manufacturing device for personalized softgel capsules provided by an embodiment of the present disclosure.

FIG. 2A and FIG. 2B are schematic views showing that capsules are offset to the left or right during online variable information printing in an embodiment of the present disclosure, wherein FIG. 2A is the normal situation and FIG. 2B shows a left offset.

FIG. 3A and FIG. 3B are schematic views showing that capsules are offset back and forth during online variable information printing in an embodiment of the present disclosure, wherein FIG. 3A is the normal situation and FIG. 3B shows a forward offset.

FIG. 4 is a flow chart of the manufacturing method of personalized softgel capsule provided by an embodiment of the present disclosure.

### DESCRIPTION OF THE EMBODIMENTS

In order to make the purpose, technical solutions and advantages of the present disclosure more clear, the present disclosure will be further described in detail below with reference to the accompanying drawings and embodiments. It should be understood that the specific embodiments described here are only used to explain the present disclosure and are not intended to limit the present disclosure.

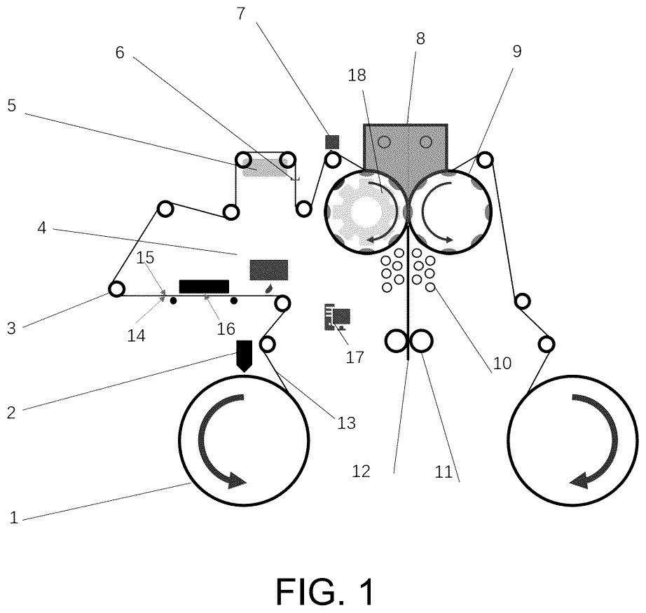

As shown in FIG. 1, the present disclosure provides a personalized softgel capsule manufacturing device, which includes a first capsule forming unit, a second capsule forming unit, a pump spray body 8, a printing unit and a control unit.

The first capsule forming unit and the second capsule forming unit are arranged symmetrically on left and right, and are respectively used to form gelatin sheets 13 and compress them to form a pill. The structures of the first capsule forming unit and the second capsule forming unit are the same, and both of them include a casting drum 1, several feeding rollers 3 and a pilling mold 9 that are disposed in sequence from front to back along a transport direction of the gelatin sheet 13, and also include a spreading box 2 arranged above the casting drum 1. During operation, the gelatin liquid is dropped onto the casting drum 1 through the spreading box 2. Since the temperature of the casting drum 1 is relatively low, the gelatin liquid is slowly solidified into a gelatin sheet 13 on the casting drum 1. One side of the gelatin sheet 13 that fits the casting drum 1 is a sheet seaming surface 14, and one side away from the casting drum 1 is a sheet printing surface 15. The casting drum 1 is always in a rotating state after operation, and then continuously transports the gelatin sheet 13. The gelatin sheet 13 is ultimately sent to the pilling mold 9 through multiple feeding rollers 3 to be compressed into the pill.

The pump spray body 8 is disposed directly above the two pilling molds 9 and is used to inject liquid into the pill to form the softgel capsule 10. The blank sheet 12 is pulled out by the sheet pull-out roller 11 and transported to a waste bucket.

The printing unit includes a printing nozzle 4, a left and right correction assembly and a front and rear correction assembly that are disposed on the first capsule forming unit in sequence from front to back along a transport direction of the gelatin sheet 13. The printing nozzle 4 is disposed at the next station where the casting drum 1 outputs the gelatin sheet 13, and is used to continuously print on the sheet printing surface 15 of the gelatin sheet 13 to form a pattern. Moreover, the oil-free surface of the gelatin sheet 13 may ensure printing accuracy and avoid problems such as blur, distortion, and offset. The left and right correction assembly is used to detect the edges of the gelatin sheet 13 to adjust the gelatin sheet 13 to the left or right to ensure that the pattern is located in the center of the softgel capsule 10. The front and rear correction assembly is used to detect the pattern position and the rotation position and rotation angle of the pilling mold 9, and then adjust the printing position of the printing nozzle 4 back and forth to ensure that the pattern is located in the center of the softgel capsule 10.

The control unit 17 is connected to the printing unit and is used to receive detection information and control the printing unit.

Furthermore, the printing nozzle 4 is a combination of one or more nozzles. The number of the printing nozzle 4 is preferably 1 to 10. The effective printing width of the printing nozzle 4 needs to completely cover the width of the gelatin sheet 13. The printing mode of the printing nozzle 4 is: One Pass (that is, the pattern is formed at a time), this printing mode is characterized in fast speed and high efficiency. The printing nozzle 4 does not need to move during the printing process, and the casting drum 1 does not need to be stopped. Such printing mode is very suitable for continuous and mass printing, thus effectively improving printing efficiency and reducing production costs. In the meantime, the printing nozzle 4 is connected to the control unit 17 and may adjust the printing content in real time under the control of the control unit 17. Compared with the conventional technology that uses separate process equipment and fixed transfer molds, the present disclosure may realize online variable information digital printing. In the meantime, the control unit 17 and the printing nozzle 4 may accurately control the addition and proportion of colors to ensure the consistency and stability of the printing effect.

Furthermore, the ink used for printing is made of edible materials, and the natural drying process is relatively slow. Therefore, the printing unit also includes a dryer 16. The dryer 16 is disposed between the printing nozzle 4 and the left and right correction assembly to speed up the drying of the ink while ensuring the quality of the printed pattern, thus effectively improving the operation speed of the device.

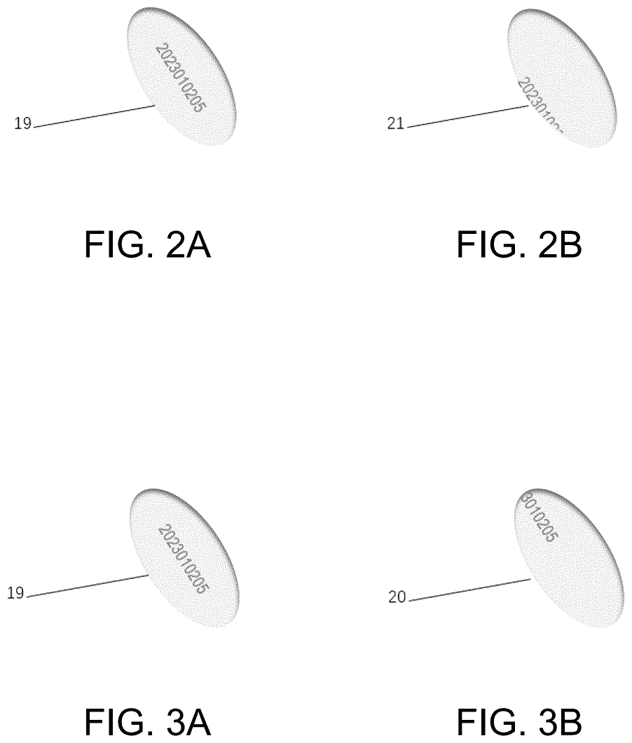

Moreover, the left and right correction assembly includes an edge sensor 6 and a correction device 5 disposed in sequence from back to front. The edge sensor 6 is disposed above the gelatin sheet 13 and is used to detect the edge of the gelatin sheet 13, and sends the detection information to the correction device 5. The correction device 5 is disposed between two adjacent feeding rollers 3 and is used to adjust the gelatin sheet 13 to the left or right according to the detection information to ensure that the pattern is located in the center of the softgel capsule 10 when the gelatin sheet enters the pilling mold 9. During operation, if the gelatin sheet 13 is offset to the left or right, the edge sensor 6 will send an electrical signal to the correction device 5, and the correction device 5 will automatically correct the gelatin sheet 13 according to the electrical signal of the edge sensor 6, so that the gelatin sheet 13 is always in the same horizontal position when entering the pilling mold 9, thereby ensuring that the printed pattern may be in the center of the softgel capsule 10 and will be deflected left and right. FIG. 2A shows a softgel capsule 19 in the normal printing state, and FIG. 2B shows a softgel capsule 21 whose printing pattern is in the left offset state. By adding the left and right correction assembly, it is possible to avoid left and right offsets, thereby ensuring that the printed pattern is complete and free of defects.

Moreover, the front and rear correction assembly includes a detection probe 7 and an encoder 18 disposed in sequence from front to back. The detection probe 7 is disposed above the printing surface 15 and is used to detect the pattern position on the gelatin sheet 13 and send the detection information to the control unit 17. The encoder 18 is disposed in the pilling mold 9 to detect the rotation position and rotation angle of the pilling mold 9, and sends the detection information to the control unit 17, thereby using the control unit 17 to adjust the printing position of the printing nozzle 4. In operation, the detection probe 7 will send an electrical signal to the control unit 17 after detecting the pattern, and the encoder 18 will continue to send electrical signals to the control unit 17, so that the control unit 17 knows the current rotation position and rotation angle of the pilling mold 9. After the control unit 17 receives the electrical signal from the detection probe 7 and the encoder 18 and performs calculation, the electrical signal is sent to the printing nozzle 4 so that the printing pattern moves forward or backward on the sheet printing surface 15 to meet the requirements that the pattern is always in the center of the softgel capsule when the pilling mode 9 compresses the pill. FIG. 3A shows a softgel capsule 19 in the normal printing state, and FIG. 3B shows a softgel capsule 20 whose printing pattern is in the forward offset state. By adding the front and rear correction assembly, it is possible to avoid front and rear offsets, thereby ensuring that the printed pattern is complete and free of defects.

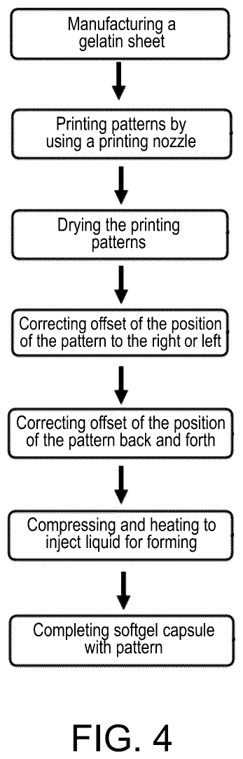

As shown in FIG. 4, according to another aspect of the present disclosure, a method for manufacturing personalized softgel capsules using the above device is provided. The method includes the following steps:
S1. The gelatin liquid is dropped onto the casting drum 1 through the spreading box 2 and solidified into a gelatin sheet 13. One side of the gelatin sheet 13 that fits the casting drum 1 is a sheet seaming surface 14, and one side away from the casting drum 1 is a sheet printing surface 15. Several feeding rollers 3 are used to transport gelatin sheets 13.
S2. The printing nozzle 4 is used to print the pattern on the sheet printing surface 15 and the dryer 16 is used to dry the pattern, and then transportation is continued through the feeding roller 3.
S3. The left and right correction assembly is used to detect the edges of the gelatin sheet 13, adjust the gelatin sheet 13 to the left or right to ensure that the pattern is located in the center of the softgel capsule, and the gelatin sheet is continuously transported. Specifically, the edge sensor 6 is used to detect the edge of the gelatin sheet 13, and the detection information is sent to the correction device 5. The correction device 5 adjusts the gelatin sheet 13 to the left or right according to the detection information.
S4. The front and rear correction assembly is used to detect the pattern position and the rotation position and rotation angle of the pilling mold 9 and transmits the data to the control unit 17. The control unit 17 is used to adjust the printing position of the printing nozzle 4 back and forth to ensure that the pattern is located in the center of the softgel capsule. Specifically, the detection probe 7 detects the pattern on the gelatin sheet 13 and sends an electrical signal to the control unit 17. In the meantime, the encoder 18 detects the rotation position and rotation angle of the pilling mold 9, and sends the detection information to the control unit 17. The control unit 17 adjusts the printing position of the printing nozzle 4 back and forth according to the detection information to ensure that the pattern is located in the center of the softgel capsule.
S5. The gelatin sheet 13 enters the pilling mold 9 for compression and heating, while the pump spray body 8 injects liquid to form a patterned softgel capsule 10, thereby completing the production of personalized softgel capsules.

It is easy for those skilled in the art to understand that the above descriptions are only preferred embodiments of the present disclosure and are not intended to limit the present disclosure. Any modifications, equivalent substitutions and improvements, etc., made within the spirit and principles of the present disclosure should all be included in the scope to be protected by the present disclosure.

What is claimed is:

1. A personalized softgel capsule manufacturing device comprising a first capsule forming unit, a second capsule forming unit, a pump spray body, a printing unit and a control unit, wherein:
the first capsule forming unit and the second capsule forming unit are disposed symmetrically on left and right, and are respectively disposed to form a gelatin sheet and compress the gelatin sheet to form a pill, structures of the first capsule forming unit and the second capsule forming unit are the same, and both of the first capsule forming unit and the second capsule forming unit comprise a casting drum, a plurality of feeding rollers and a pilling mold that are disposed in sequence from front to back along a transport direction of the gelatin sheet, and comprise a spreading box disposed above the casting drum;
the pump spray body is disposed directly above two the pilling mold and is disposed to spray liquid into the pill to form a softgel capsule;
the printing unit comprises a printing nozzle, a left and right correction assembly and a front and rear correction assembly that are disposed on the first capsule forming unit in sequence from front to back along the transport direction of the gelatin sheet, the printing nozzle is disposed to continuously print on a sheet printing surface of the gelatin sheet to form a pattern; the left and right correction assembly is disposed to detect an edge of the gelatin sheet to adjust the gelatin sheet to the left or right to ensure that the pattern is located in a center of the softgel capsule; the front and rear correction assembly is disposed to detect a pattern position and a rotation position and a rotation angle of the pilling mold, and then adjust a printing position of the printing nozzle back and forth to ensure that the pattern is located in the center of the softgel capsule;
the control unit is connected to the printing unit and is disposed for receiving detection information and controlling the printing unit.

2. The personalized softgel capsule manufacturing device according to claim 1, wherein the printing nozzle adopts a one-time forming printing mode.

3. The personalized softgel capsule manufacturing device according to claim 2, wherein the front and rear correction assembly comprises a detection probe and an encoder disposed in sequence from front to back, the detection probe is disposed above the sheet printing surface and is used to detect the pattern position on the gelatin sheet and send the detection information to the control unit; the encoder is disposed in the pilling mold to detect the rotation position and the rotation angle of the pilling mold, and sends the detection information to the control unit, thereby using the control unit to adjust the printing position of the printing nozzle.

4. The personalized softgel capsule manufacturing device according to claim 1, wherein a number of the printing nozzle is 1 to 10.

5. The personalized softgel capsule manufacturing device according to claim 4, wherein the front and rear correction assembly comprises a detection probe and an encoder disposed in sequence from front to back, the detection probe is disposed above the sheet printing surface and is used to detect the pattern position on the gelatin sheet and send the detection information to the control unit; the encoder is disposed in the pilling mold to detect the rotation position and the rotation angle of the pilling mold, and sends the detection information to the control unit, thereby using the control unit to adjust the printing position of the printing nozzle.

6. The personalized softgel capsule manufacturing device according to claim 1, wherein the printing unit further comprises a dryer, which is disposed between the printing nozzle and the left and right correction assembly for drying the pattern.

7. The personalized softgel capsule manufacturing device according to claim 6, wherein the front and rear correction assembly comprises a detection probe and an encoder disposed in sequence from front to back, the detection probe is disposed above the sheet printing surface and is used to detect the pattern position on the gelatin sheet and send the detection information to the control unit; the encoder is disposed in the pilling mold to detect the rotation position and the rotation angle of the pilling mold, and sends the detection information to the control unit, thereby using the control unit to adjust the printing position of the printing nozzle.

8. The personalized softgel capsule manufacturing device according to claim 1, wherein the left and right correction assembly comprises an edge sensor and a correction device disposed in sequence from back to front, the edge sensor is disposed above the gelatin sheet and is disposed to detect the edge of the gelatin sheet, and sends the detection information to the correction device; the correction device is disposed between two of the adjacent feeding rollers and is disposed to adjust the gelatin sheet to the left or right according to the detection information to ensure that the pattern is located in the center of the softgel capsule when the gelatin sheet enters the pilling mold.

9. The personalized softgel capsule manufacturing device according to claim 8, wherein the front and rear correction assembly comprises a detection probe and an encoder disposed in sequence from front to back, the detection probe is disposed above the sheet printing surface and is used to detect the pattern position on the gelatin sheet and send the detection information to the control unit; the encoder is disposed in the pilling mold to detect the rotation position and the rotation angle of the pilling mold, and sends the detection information to the control unit, thereby using the control unit to adjust the printing position of the printing nozzle.

10. The personalized softgel capsule manufacturing device according to claim 1, wherein the front and rear correction assembly comprises a detection probe and an encoder disposed in sequence from front to back, the detection probe is disposed above the sheet printing surface and is used to detect the pattern position on the gelatin sheet and send the detection information to the control unit; the encoder is disposed in the pilling mold to detect the rotation position and the rotation angle of the pilling mold, and sends the detection information to the control unit, thereby using the control unit to adjust the printing position of the printing nozzle.

11. A manufacturing method for a personalized softgel capsule using the manufacturing device according to claim 1, wherein method comprises:
S1. gelatin liquid is dropped onto the casting drum through the spreading box and solidified into the gelatin sheet, one side of the gelatin sheet that fits the casting drum is a sheet seaming surface, and one side away from the casting drum is the sheet printing surface, some of the feeding rollers are utilized to transport the gelatin sheet;
S2. the printing nozzle is utilized to print the pattern on the sheet printing surface and the gelatin sheet is continuously transported;
S3. the left and right correction assembly is utilized to detect the edge of the gelatin sheet, adjust the gelatin sheet to the left or right to ensure that the pattern is located in the center of the softgel capsule, and the gelatin sheet is continuously transported;
S4. the front and rear correction assembly is utilized to detect the pattern position and the rotation position and the rotation angle of the pilling mold and transmits data to the control unit, the control unit is utilized to adjust the printing position of the printing nozzle back and forth to ensure that the pattern is located in the center of the softgel capsule;
S5. the gelatin sheet enters the pilling mold for compression and heating, while the pump spray body injects the liquid to form a patterned softgel capsule, thereby completing production of the personalized softgel capsule.

12. The manufacturing method of the personalized softgel capsule according to claim 11, wherein step S2 further comprises: drying the pattern using the dryer.

13. The manufacturing method of the personalized softgel capsule according to claim 12, wherein step S4 comprises: after the detection probe detects the pattern on the gelatin sheet, the detection probe sends an electrical signal to the control unit, and the encoder detects the rotation position and the rotation angle of the pilling mold, and sends the detection information to the control unit, the control unit adjusts the printing position of the printing nozzle back and forth according to the detection information to ensure that the pattern is located in the center of the softgel capsule.

14. The manufacturing method of the personalized softgel capsule according to claim 11, wherein step S3 comprises: using the edge sensor to detect the edge of the gelatin sheet, and sending the detection information to the correction device; the correction device adjusts the gelatin sheet to the left or right according to the detection information.

15. The manufacturing method of the personalized softgel capsule according to claim 14, wherein step S4 comprises: after the detection probe detects the pattern on the gelatin sheet, the detection probe sends an electrical signal to the control unit, and the encoder detects the rotation position and the rotation angle of the pilling mold, and sends the detection information to the control unit, the control unit adjusts the printing position of the printing nozzle back and forth according to the detection information to ensure that the pattern is located in the center of the softgel capsule.

16. The manufacturing method of the personalized softgel capsule according to claim 11, wherein step S4 comprises: after the detection probe detects the pattern on the gelatin sheet, the detection probe sends an electrical signal to the control unit, and the encoder detects the rotation position and the rotation angle of the pilling mold, and sends the detection information to the control unit, the control unit adjusts the printing position of the printing nozzle back and forth according to the detection information to ensure that the pattern is located in the center of the softgel capsule.
